(19) United States
(12) Patent Application Publication
(10) Pub. No.: US 2002/0163281 A1
(43) Pub. Date: Nov. 7, 2002

(54) Thin film motors

(76) Inventor: Menachem Rafaelof, Superior, CO (US)

Correspondence Address: MOSER, PATTERSON & SHERIDAN, LLP, 4149 El Camino Way, Suite B, Palo Alto, CA, 94306-4036, US

(21) Appl. No.: 10/016,991

(22) Filed: Dec. 13, 2001

Related U.S. Application Data
(60) Provisional application No. 60/288,987, filed on May 4, 2001.

(51) Int. Cl. H02N 1/00

(52) U.S. Cl. 310/309

(57) ABSTRACT

Apparatus for an electrostatic spindle motor is disclosed. More particularly, a stator having a first plurality of surface electrodes is spaced apart from a rotor having a second plurality of surface electrodes for capacitive coupling. At least one of the first plurality of surface electrodes and the second plurality of surface electrodes is configured to conduct electrical charge. A source is configured to provide electrical charge to the at least one of the first plurality of surface electrodes and the second plurality of surface electrodes and to alternate electrical polarity. The rotor and the stator may comprise bearing surfaces to provide a fluid dynamic bearing.

### CROSS-REFERENCE TO RELATED APPLICATIONS

This application claims benefit of U.S. provisional Patent Application, application No. 60/288,987, filed May 4, 2001, which is incorporated by reference herein in its entirety.

### FIELD OF THE INVENTION

The present invention relates generally to electric motors, and more particularly to thin film motors for disc drives.

### BACKGROUND OF THE INVENTION

A form of an information storage and retrieval device is a hard disc drive [hereinafter “disc drive”]. A disc drive is conventionally used for information storage and retrieval with computers, data recorders, redundant arrays of independent discs (RAIDs), multi-media recorders, and the like. A disc drive comprises one or more disc media.

Each disc media comprises a substrate upon which materials are deposited to provide a magnetically sensitive surface. In forming a disc media, a substrate is ground or polished, conventionally by chemical-mechanical or mechanical polishing, to provide a substantially planar surface. Layers of materials are substantially uniformly deposited on this substantially planar surface to provide magnetic properties for writing to and reading from the disc media.

Recently, disc media have been increasing in data density due to increases in storage track density. Though data density has increased, a persistent limitation in disc drive performance is time for writing and reading information from the disc media. A measure of disc drive performance is data transfer rate, namely, the rate at which data may be read from a disc media. A significant factor in data transfer rate is spindle speed, which translates into rate of rotation of the disc media.

Increasing motor speed for rotating a disc media facilitates increasing data transfer rate. However, disc drives are conventionally limited by space constraints of computer manufacturers and other disc drive users, and thus motor size is likewise constrained. Moreover, disc drives are further conventionally limited by power constraints of computer manufacturers and other disc drive users, and thus power consumption is likewise constrained. Furthermore, as motor speed increases requiring more electrical power, inefficiency of conventional electromagnetic motors increases.

Accordingly, it would be desirable and useful to provide an electric motor that would facilitate: higher motor speeds by increasing efficiency to reduce power consumption as compared to conventional motors operating at equivalent speeds. It would be additionally desirable and useful if such an electric motor facilitated a more compact disc drive design than conventional spindle motors with less complicated construction for lower cost.

### SUMMARY OF THE INVENTION

An aspect of the present invention is an electrostatic spindle motor. More particularly, a stator having a first plurality of surface electrodes is spaced apart from a rotor having a second plurality of surface electrodes for capacitive coupling. At least one of the first plurality of surface electrodes and the second plurality of surface electrodes is configured to conduct electrical charge. A source is configured to provide electrical charge to the at least one of the first plurality of surface electrodes and the second plurality of surface electrodes and to alternate electrical polarity.

Another aspect of the present invention is the above-described electrostatic spindle motor where the rotor and the stator comprise bearing surfaces to provide a fluid dynamic bearing.

### BRIEF DESCRIPTION OF THE DRAWINGS

So that the manner in which the above recited features, advantages and objects of the present invention are attained and can be understood in detail, a more particular description of the present invention, briefly summarized above, may be had by reference to the embodiments thereof which are illustrated in the appended drawings. It is to be noted, however, that the appended drawings illustrate only typical embodiments of the present invention and are therefore not to be considered limiting of its scope, for the present invention may admit to other equally effective embodiments.

FIG. 1 is a top plan view of an exemplary portion of an embodiment of a disc drive in accordance with one or more aspects of the present invention.

FIG. 2A is a cross sectional view of an exemplary portion of an embodiment of an electric motor in accordance with one or more aspects of the present invention.

FIG. 2B is a cross sectional view of an exemplary portion of an alternative embodiment of an electric motor in accordance with one or more aspects of the present invention.

FIG. 3A is a cross sectional view of an exemplary portion of an embodiment of an electric spindle motor in accordance with one or more aspects of the present invention.

FIG. 3B is a cross sectional view of an exemplary portion of an alternative embodiment of an electric motor in accordance with one or more aspects of the present invention.

FIG. 4A is a cross sectional view of an exemplary portion of the electric spindle motor of FIG. 3A in accordance with one or more aspects of the present invention.

FIG. 4B is a cross sectional view of an exemplary portion of the electric spindle motor of FIG. 3B in accordance with one or more aspects of the present invention.

FIG. 5 is a cross sectional view of an exemplary portion of the electric spindle motor of FIGS. 3A and 3B in accordance with one or more aspects of the present invention.

While foregoing is directed to the preferred embodiment of the present invention, other and further embodiments of the invention may be devised without departing from the basic scope thereof, and the scope thereof is determined by the claims that follow.

### DETAILED DESCRIPTION OF THE DRAWINGS

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

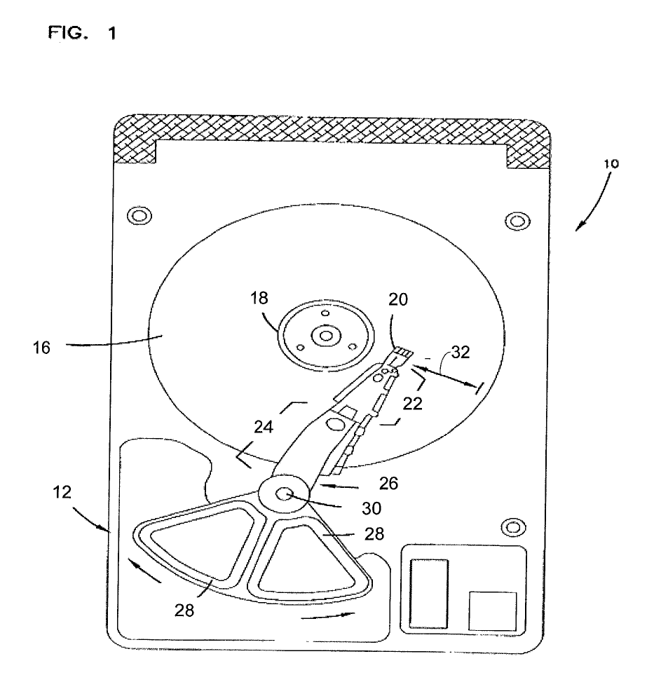

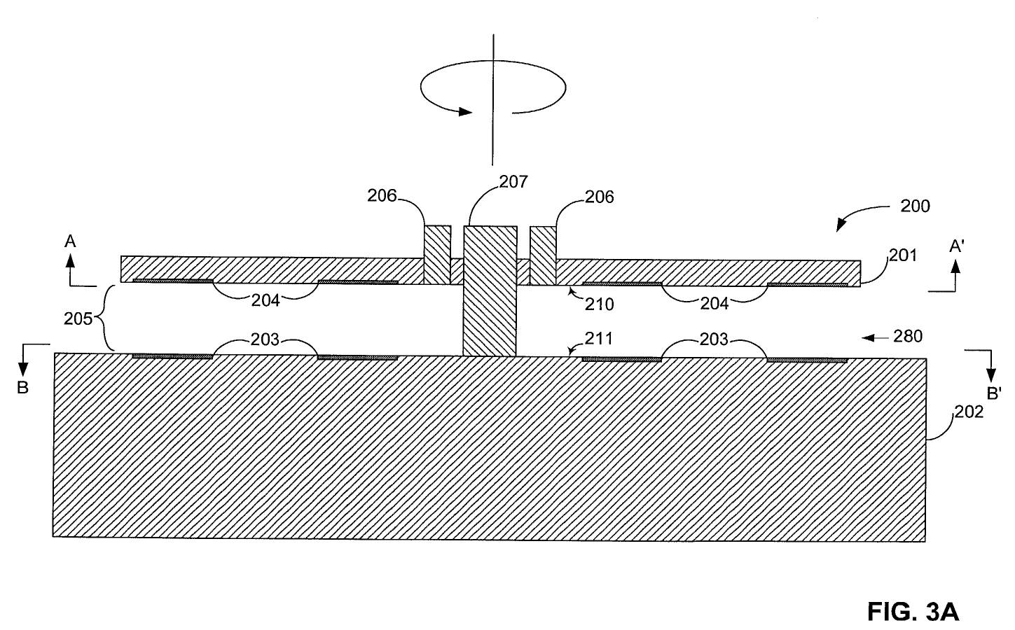

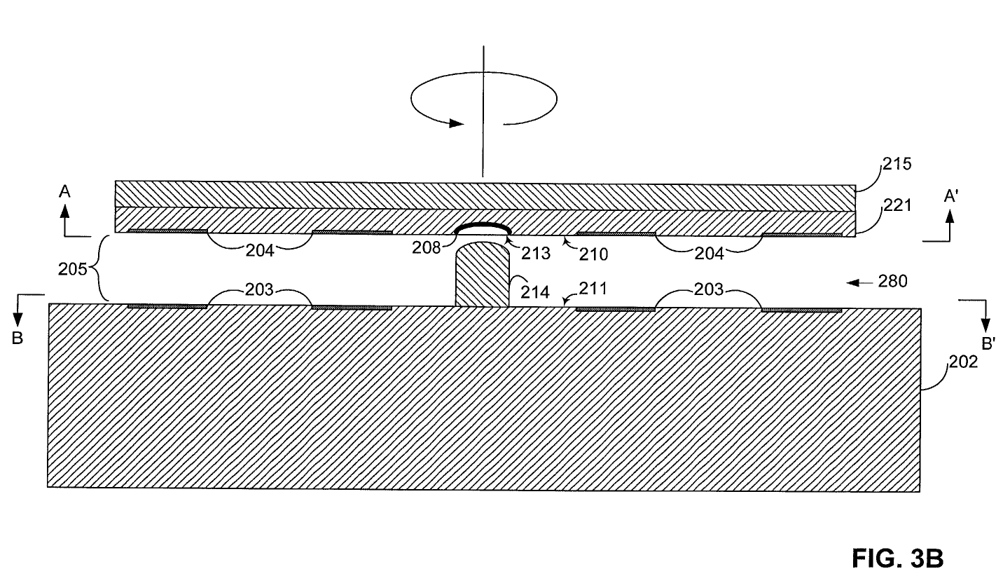

Referring to FIG. 1, there is shown a top plan view of an exemplary portion of an embodiment of a disc drive 10 in accordance with one or more aspects of the present invention. Disc drive 10 comprises housing base 12, disc media 16, disc clamp 18, head mounting arm 24, flexure 22, read/write (R/W) head assembly 20, voice coil motor 28, actuator body 26, and pivot shaft 30. R/W head assembly 20 is moved in curvilinear directions 32 across disc media 16. Disc media 16 may be coupled, using disc clamp 18, for rotation by a spindle motor, for example the spindle motor of FIG. 3A. Though a single disc media 16 is shown, it should be understood that multiple disc media may be used.

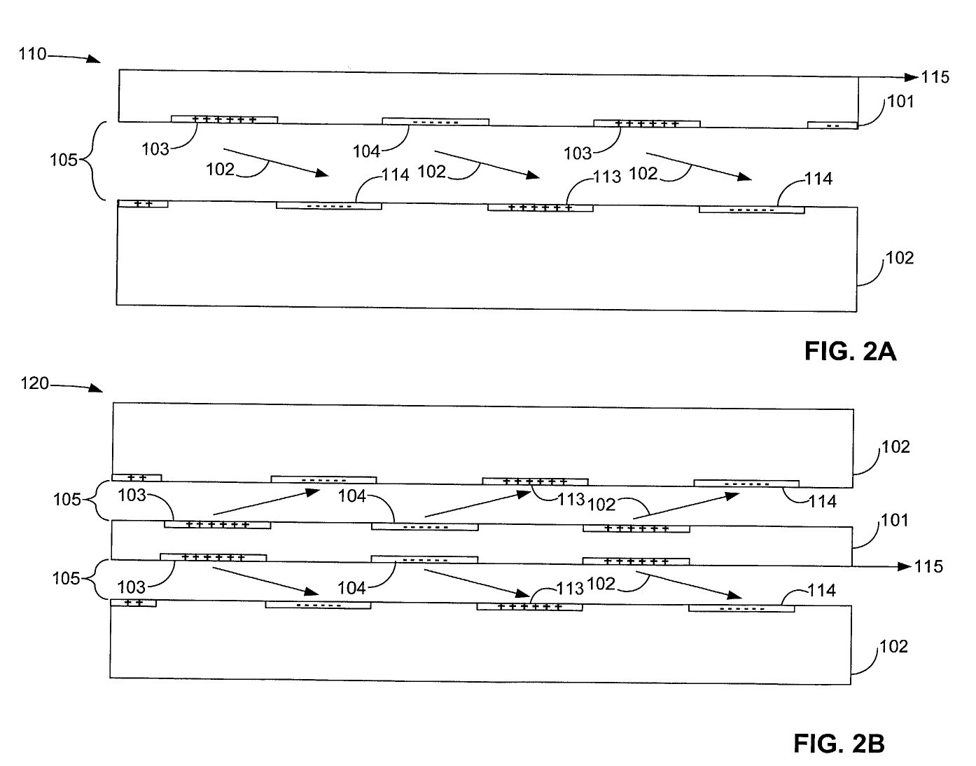

Referring to FIG. 2A, there is shown a cross sectional view of an exemplary portion of an embodiment of an electric motor 110 in accordance with one or more aspects of the present invention. Motor 110 is a linear actuator comprising linearly movable portion 101 and stator portion 102. FIG. 2A illustratively shows a principle of actuation using a linear motor 110 that may be extrapolated for operation of a rotor in place of linearly movable portion 101.

Linearly movable portion or plate 101 is formed from a thin film substrate assembly with electrode regions 103 and 104. Because thin film techniques may be employed, electrode regions may be formed relatively thin, as described below, to enhance performance. Electrode regions 103 are positively charged, and electrode regions 104 are negatively charged. Stator 102 comprises electrode regions 113 and 114. Electrode regions 113 and 114 may be alternatingly electrified to produce positive and negative charge. In other words, electric charge polarity may be alternated from one electrode region to the next.

Electric actuation, also referred to as electrostatic actuation and capacitive actuation, may be realized when two surfaces with opposite charge are placed in close proximity to one another. Opposite charges on such two surfaces, namely electrode regions 103, 104 and electrode regions 113, 114, produce electric forces to increase capacitance between such surfaces. Electric forces produced will tend toward maximizing such capacitance. Thus, plate 101 is capable of moving parallel with respect to stator 102, as indicated by arrow 115. In other words, positive and negative forces will tend to attract, as indicated by arrows 102, to align themselves. By controlling charges on electrodes 113 and 114, either or both attractive and repulsive forces may be used to cause linear motion.

To produce linear and continuous range of motion, matching conductive surface electrodes may be patterned on opposed stator and rotor surfaces. Formation of surface electrodes, such as electrode regions 103, 104 as well as electrode regions 113, 114, may be done with conventional thin film coating techniques, including but not limited to lithography, etch, deposition, and polishing, and/or conventional micro-electro-mechanical system (“MEMS”) processes, such as bulk etching, sacrificial deposition and etching, and the like. Surface electrode regions 103 and 104 may be commonly grounded through a bearing to a base plate. Alternatively, surface electrode regions 103 and 104 may be left electrically floating or grounded, in which embodiment a ramping voltage is applied to electrodes 113 and 114 in sequence to cause linear actuator plate 101 to move. Notably, a constant ramping voltage may be used. To enhance energy delivery, another stator may be used as described below in more detail.

Referring to FIG. 2B, there is shown a cross sectional view of an exemplary portion of an alternative embodiment of an electric motor 120 in accordance with one or more aspects of the present invention. Electric motor 120 of FIG. 2B is similar to electric motor 110 of FIG. 2A, except that linear actuator plate 101 has disposed in it electrodes 103 and 104 on upper and lower surfaces opposed to respective stators 102. Accordingly, electromotive force is generated in two gaps 105 instead of just one gap 105, as in FIG. 2A.

The above-described electric actuation for linear motion is likewise applicable for rotational motion. Electric actuation for rotational motion is described below in terms of a spindle motor for a disc drive.

Referring to FIG. 3A, there is shown a cross sectional view of an exemplary portion of an embodiment of an electric spindle motor 200 in accordance with one or more aspects of the present invention. Spindle motor 200 comprises rotor 201, stator 202, shaft 207 and ring bearing 206. Gap 205 is approximately equal to or less than five microns, and may be in a range of one to five microns. Rotor 201 comprises surface electrodes 204, which may be formed flush or recessed with respect to bottom surface 210. More particularly, surface electrodes 204 may be approximately 0.2 microns thick or less to appear flush with bottom surface 210. Stator 202 comprises surface electrodes 203, which may be formed flush or recessed with respect to bottom surface 211. More particularly, surface electrodes 203 may be approximately 0.2 microns thick or less to appear flush with top surface 211. Surfaces 210 and 211 may be formed substantially planar, while another of surfaces 210 and 211 comprises a “herring bone” pattern (not shown).

Formation of surfaces 210 and 211, as well as surface electrodes 203 and 204, may be done with conventional thin film coating techniques, including but not limited to lithography, deposition, and polishing, and/or conventional micro-electro-mechanical system (“MEMS”) processes. Creation of thin film electrodes may comprise deposition of one or more conductive layers (“metal”), depostion of resist on the metal, mask creation, lithography (expositing the resist through the mask), development, and etching the metal to create an electrode pattern. Creation of grooves for a “herring bone” pattern (not shown) or other pattern for a fluid dynamic bearing may be done conventionally, though notably made considerably more simple by formation on a planar, instead of cylindrical, surface.

In an embodiment, gap 205 is an air gap, and ring bearing 206 and shaft 207, including but not limited to a fluid dynamic bearing, are employed where rotor 201 is part of a spindle motor hub. In another embodiment, rotor 201 is a disc media and ring bearing 206 and shaft 207, including but not limited to a fluid dynamic bearing, are employed. More details regarding conventional fluid dynamic bearing assemblies for disc drives may be found in U.S. Pat. Nos. 5,685,647 to Leuthold et al. and 5,577,842 to Parsoneault et al., each of which is incorporated by reference as though fully set forth herein in entirety.

In another embodiment, at least one of bottom surface 210 and top surface 211 have a pattern, such as a “herring bone” pattern formed thereon for a fluid dynamic bearing. In this embodiment, fluid 280 is used to maintain gap 205 between rotor 201 and stator 202. Such fluid is preferably chosen such that its dielectric constant is greater than that of air. For example, known fluids may be used with a dielectric constant in a range of approximately 8 to 10. Use of a dielectric constant greater than air, namely greater than one, in gap 205 facilitates an increase in capacitive coupling between stator 202 and rotor 201, which in turn produces more electromagnetic actuation.

Moreover, by integrating motor 200 and spindle bearing surfaces 210 or 211, control of tolerances is facilitated. At least one of surfaces 210 and 211 may be formed with precise semiconductor manufacturing techniques to improve bearing run outs and bearing tolerances. Moreover, because surfaces 210 and 211 are flat, as compared with conventional fluid dynamic bearing surfaces that are cylindrical, surfaces 210 and 211 facilitate simpler implementation as compared with conventional spindle motors, lower manufacturing/tooling cost as compared with conventional spindle motors, and tighter control of tolerances, including bearing run outs. Furthermore, thinness of gap 205 facilitates capillary action, for providing capillary sealing.

Referring to FIG. 3B, there is shown a cross sectional view of an exemplary portion of an alternative embodiment of an electric motor 299 in accordance with one or more aspects of the present invention. Electric motor 299 has many elements that are described above with respect to electric motor 200 of FIG. 3A, and thus are not repeated here. However, rather than a conventional ring bearing 206 and shaft 207, dimple 213 and nub 214 are used. Dimple 213 and nub 214 are used to maintain lateral position of rotor 221 when motor 299 is not in operation. When operating, electromotive forces may be used to maintain position of rotor 221. Optionally, one or more coating layers 208 may be used in dimple 213 to improve wear of rotor 221. Optionally, if rotor 221 is not a disc media, then disc media 215 may be attached to rotor 221. Notably, to secure rotor 221 and disc media 215 in place in the presence of external shock, a trust bearing (not shown) may be added to constrain vertical motion.

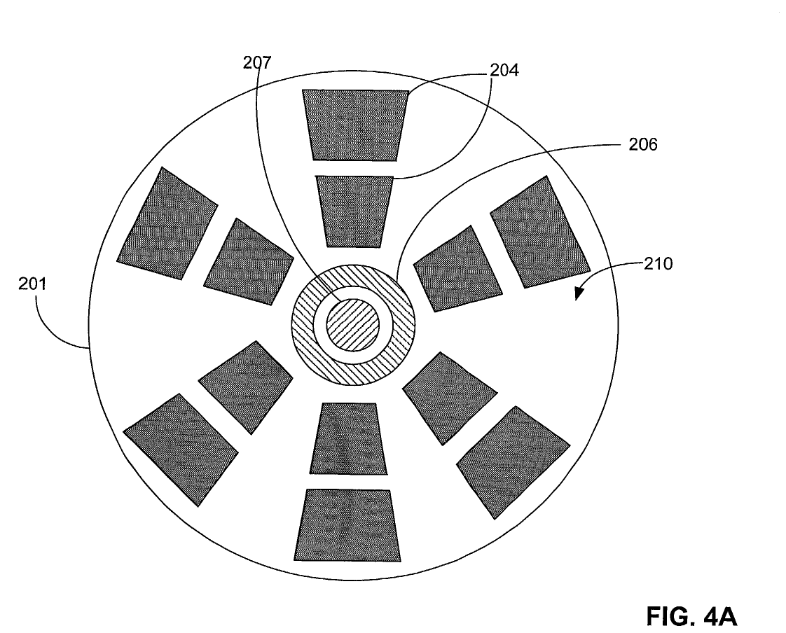

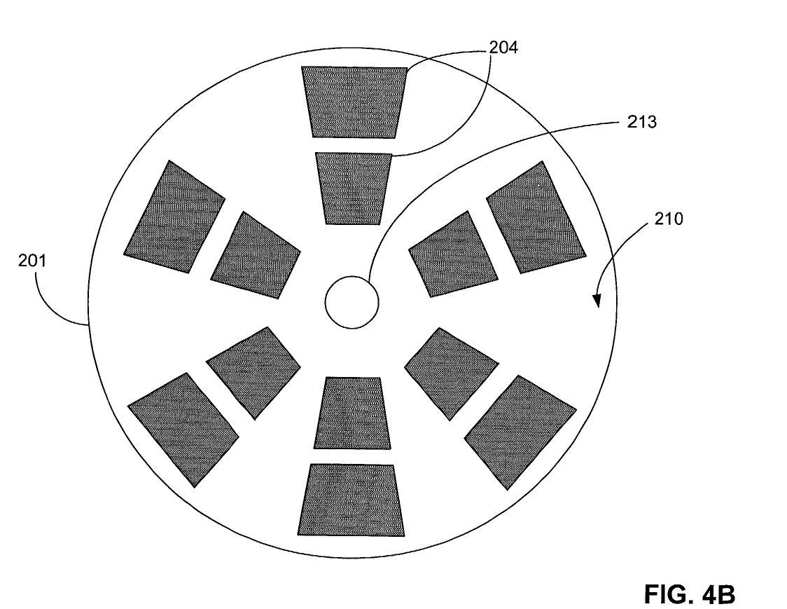

Referring to FIG. 4A, there is shown a cross sectional view of an exemplary portion of rotor 201 of FIG. 3A in accordance with one or more aspects of the present invention. Electrodes 204 may be circumferentially disposed on surface 210 of rotor 201. Though two concentric rows of electrode pads 204 are shown, fewer or more rows may be used. Moreover, though six sections of electrode pads 204 are shown, fewer or more sections may be used. Notably, the number of sections of electrode pads 204 should be different in number than opposing electrode pads on stator 202.

Referring to FIG. 4B, there is shown a cross sectional view of an exemplary portion of rotor 221 of FIG. 3B in accordance with one or more aspects of the present invention. Rotor 221 has many elements that are described above with respect to rotor 201 of FIG. 4A, and thus are not repeated here.

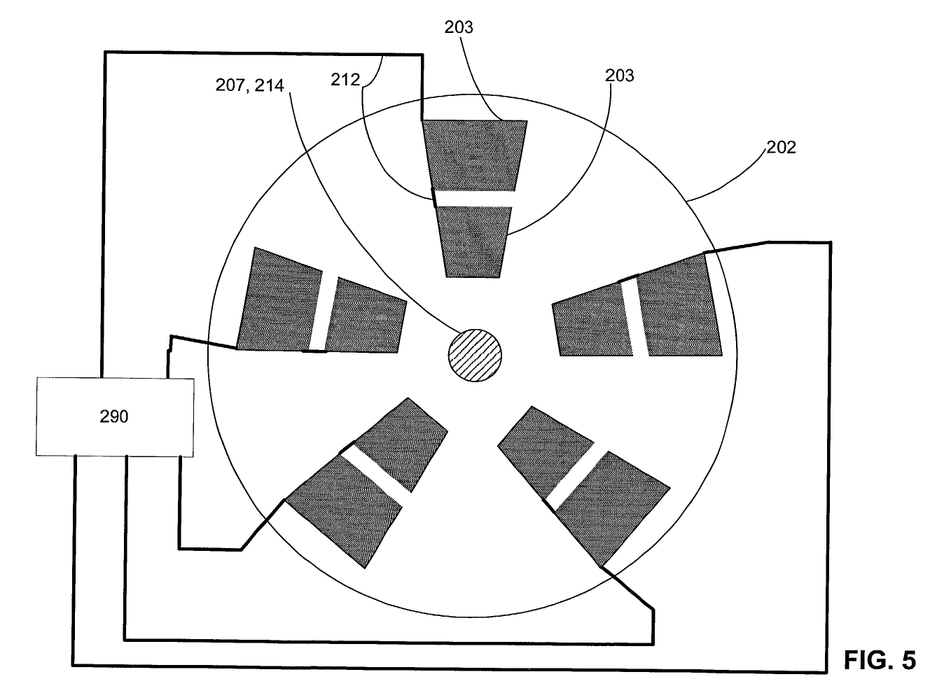

Referring to FIG. 5, there is shown a cross sectional view of an exemplary portion of stator 202 of FIGS. 3A and 3B in accordance with one or more aspects of the present invention. Electrodes 203 are disposed on surface 211 of stator 202. Though two rows of electrode pads 203 are shown, fewer or more rows may be used. Moreover, though five sections of electrode pads 203 are shown, fewer or more sections may be used. Notably, the number of sections of electrode pads 203 should be different in number than opposing electrode pads on a corresponding rotor 201, 221. Wires 212 are used to apply electricity to electrode pads 203. Source of control and application of electricity 290 may be any of a variety of known electrical sources consistent with operation of electrostatic motors.

Notably, it is desirable to increase the number of circumferential electrode pads to allow three groups of pads, such as nine pads in three groups. In this manner, each group of pads may be connected as a single-phase motor (60 degrees apart or phase spaced). Commutation then may be achieved by increasing voltage on one or two phases while decreasing voltage on two or one remaining phases. This will result in even actuation forces on rotor 201, 221, and consequently smoother motion.

Advantageously, a motor in accordance with one or more aspects of the present invention reduces to eliminates back electromotive force (emf) as compared with conventional electromagnetic motors. This facilitates increased spindle speeds without correspondingly increased driving voltage to overcome such back emf. Additionally, rotor position, or more particularly rotor starting position, may be measured based on capacitance of overlaping rotor and stator surface electrodes.

While foregoing is directed to the preferred embodiment of the present invention, other and further embodiments of the invention may be devised without departing from the basic scope thereof, and the scope thereof is determined by the claims that follow.

1. An electrostatic spindle motor apparatus, comprising:
a stator, the stator having a first plurality of surface electrodes;
a rotor, the rotor having a second plurality of surface electrodes;
the first plurality of surface electrodes spaced apart from the second plurality of electrodes to provide capacitive coupling, at least one of the first plurality of surface electrodes and the second plurality of surface electrodes configured to conduct electrical charge; and
a source configured to provide electrical charge to the at least one of the first plurality of surface electrodes and the second plurality of surface electrodes and to alternate electrical polarity.

2. The apparatus of claim 1 wherein the rotor is a disc media.

3. The apparatus of claim 1 wherein the rotor and the stator are spaced apart in a range of approximately one to five microns.

4. The apparatus of claim 1 wherein the rotor and the stator comprise opposing bearing surfaces.

5. The apparatus of claim 4 wherein the rotor comprises a herring bone pattern.

6. The apparatus of claim 4 wherein the stator comprises a herring bone pattern.

7. The apparatus of claim 1 wherein the rotor is supported at least in part with a ring bearing and a spindle shaft.

8. The apparatus of claim 7 wherein the rotor is supported with a fluid

9. The apparatus of claim 8 wherein the fluid has a dielectric constant greater than one.

10. The apparatus of claim 1 wherein the rotor is supported at least in part with a nub attached to the stator.

11. The apparatus of claim 10 wherein the rotor defines a dimple configured to receive an end of the nub.

12. An electrostatic spindle motor apparatus, comprising:
a stator, the stator having a first plurality of surface electrodes and a first fluid dynamic bearing surface;
a rotor, the rotor having a second plurality of surface electrodes and having a second fluid dynamic bearing surface;
the first plurality of surface electrodes spaced apart from the second plurality of electrodes to provide capacitive coupling, at least one of the first plurality of surface electrodes and the second plurality of surface electrodes configured to conduct electrical charge; and
a source configured to provide electrical charge to the at least one of the first plurality of surface electrodes and the second plurality of surface electrodes and to alternate electrical polarity.

13. The apparatus of claim 12 wherein the rotor and the stator are spaced apart in a range of approximately one to five microns.

14. The apparatus of claim 12 wherein the rotor comprises disc media.

15. The apparatus of claim 14 wherein the rotor comprises a herring bone pattern.

16. The apparatus of claim 14 wherein the stator comprises a herring bone pattern.

17. The apparatus of claim 14 further comprising a fluid for the first fluid dynamic bearing surface and the second fluid dynamic bearing surface, the fluid having a dielectric constant greater than one.

18. An electrostatic spindle motor apparatus, comprising:
first electrode means for providing alternating electrical charge thereto;
second electrode means spaced apart from the first electrode means for capacitive coupling with the first electrode means to provide electromotive force; and
means for providing the alternating electrical charge.

19. The apparatus of claim 18 further comprising fluid dynamic bearing surface means and fluid means in combination for maintaining a gap between the first electrode means and the second electrode means.

20. The apparatus of claim 19 wherein the fluid means has a dielectric constant greater than one.
